(19) United States
(12) Patent Application Publication
(10) Pub. No.: US 2011/0161854 A1
(43) Pub. Date: Jun. 30, 2011

(54) SYSTEMS AND METHODS FOR A SEAMLESS VISUAL PRESENTATION OF A PATIENT'S INTEGRATED HEALTH INFORMATION

(76) Inventor: Monica Harit Shukla, Bangalore, IN (US)

(21) Appl. No.: 12/647,753

(22) Filed: Dec. 28, 2009

(51) Int. Cl. G06T 15/00; G06F 3/048

(52) U.S. Cl. 715/771; 345/419

(57) ABSTRACT

Systems and methods provide visual presentation of clinical evidence to a user in association with a patient's anatomy. In certain examples, a patient information interface system to present an aggregated, graphical view of patient anatomy and history includes a data store to include images and patient history information and a processor to implement a user interface to accept user input. The processor provides a plurality of graphical representations of a human anatomy. Each graphical anatomy representation is to provide a view of a body system. Each graphical anatomy representation is to include one or more indicators corresponding to clinical events that have occurred in connection with a patient in the body system and are viewable through the graphical anatomy representation. Each of the one or more indicators is to be located at an anatomical location on the graphical representation affected by the clinical event corresponding to the indicator.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### FIELD OF INVENTION

The presently described technology relates to graphical display of patient information. More specifically, the presently described technology relates to aggregation and graphical display of patient information in a single interface.

### BACKGROUND

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, that are stored in a medical information system. Radiologist and/or other clinicians may review stored images and/or other information, for example.

Using a PACS and/or other workstation, a clinician, such as a radiologist, may perform a variety of activities, such as an image reading, to facilitate a clinical workflow. A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

It is now a common practice that medical imaging devices produce diagnostic images in a digital representation. The digital representation typically includes a two dimensional raster of the image equipped with a header. The header includes collateral information with respect to the image itself, patient demographics, imaging technology and other data important for proper presentation and diagnostic interpretation of the image. Often, diagnostic images are grouped in series. Each series represents images that have something in common while differing in details—for example, images representing anatomical cross-sections of a human body substantially normal to its vertical axis and differing by their position on that axis from top to bottom are grouped in an axial series. A single medical exam, often referred to as a “Study” or “Exam”, often includes several series of images—for example, images exposed before and after injection of contrast material or by images with different orientation or differing by any other relevant circumstance(s) of imaging procedure.

Digital images are forwarded to specialized archives equipped with proper hardware and/or software for safe storage, search, access and distribution of the images and collateral information required for successful diagnostic interpretation. An information system controlling the storage is aware of multiple current and historical medical exams carried over for the same patient, diagnostic reports rendered on the basis of the exams, and, through its interconnectivity to other information systems, can posses the knowledge of other existing clinical evidences stored on, or acquired from, the other information systems. Such evidence can be further referred as “collateral clinical evidence.”

Additionally, in diagnostic reading, rendering a diagnostic report is based not only on the newly acquired diagnostic images but also involves analysis of other current and prior clinical information, including but not limited to prior medical imaging exams. In recent history, a reading physician was naturally limited to few sources of such clinical data including probably a film jacket of one to three prior studies and other clinical evidence printed on an exam requisition form.

However, with an information revolution extending into healthcare enterprises, practically all clinical evidence is subject to storage and presentation through various information systems—sometimes accessed in separate systems, but more and more integrated for cross-system search and retrieval. Such principal availability of extensive clinical history presents a serious challenge to ergonomic design of diagnostic workstations that allow easy and effective search and navigation within a multiplicity of clinical evidence to facilitate productivity of diagnostic reading without risk of missing an important piece of clinical evidence which loss or neglecting can substantially change diagnostic conclusion or affect important details of a diagnostic report.

### BRIEF SUMMARY

Certain embodiments of the present invention provide systems and methods for visual presentation of clinical evidence to a user in association with a patient's anatomy.

In certain examples, a patient information interface system to present an aggregated, graphical view of patient anatomy and history includes a data store to include images and patient history information and a processor to implement a user interface to accept user input. The processor provides a plurality of graphical representations of a human anatomy. Each graphical anatomy representation is to provide a view of a body system. Each graphical anatomy representation is to include one or more indicators corresponding to clinical events that have occurred in connection with a patient in the body system and are viewable through the graphical anatomy representation. Each of the one or more indicators is to be located at an anatomical location on the graphical representation affected by the clinical event corresponding to the indicator.

In certain examples, a computer-implemented method for aggregating and displaying a graphical view of patient anatomy and history includes compiling patient information from a plurality of clinical information sources and identifying clinical events related to the patient based on the patient information. The method also includes graphically displaying the compiled patient information using a plurality of graphical representations of a human anatomy. Each graphical anatomy representation is to provide a view of a body system. Each of the graphical representations is to include a corresponding set of one or more indicators identifying clinical events that have occurred in connection with the patient for the body system shown in the view. Each of the one or more indicators is located at an anatomical location on the graphical representation affected by the clinical event corresponding to the indicator. The method also includes facilitating user interaction with the displayed patient clinical event indicators on each of the graphical anatomy representations.

In certain examples, a machine readable storage medium having a set of instructions for execution on a computing device is provided. The set of instructions, when executed on the computing device, cause the computing device to execute a method for aggregating and displaying a graphical view of patient anatomy and history. The method includes compiling patient information from a plurality of clinical information sources and identifying clinical events related to the patient based on the patient information. The method also includes graphically displaying the compiled patient information using a plurality of graphical representations of a human anatomy. Each graphical anatomy representation is to provide a view of a body system. Each of the graphical representations is to include a corresponding set of one or more indicators identifying clinical events that have occurred in connection with the patient for the body system shown in the view. Each of the one or more indicators is located at an anatomical location on the graphical representation affected by the clinical event corresponding to the indicator. The method also includes facilitating user interaction with the displayed patient clinical event indicators on each of the graphical anatomy representations.

### BRIEF DESCRIPTION OF SEVERAL VIEWS OF THE DRAWINGS

FIG. 1 illustrates an example graphical workflow manager.

FIG. 2 depicts an example information system to implement a graphical workflow manager.

FIG. 3 depicts a flow diagram for an example method for display of and interaction with patient clinical information via a visual anatomical representation.

FIG. 4 is a schematic diagram of an example processor platform that can be used and/or programmed to implement the example systems and methods described above.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, etc. storing the software and/or firmware.

Certain embodiments provide a single view of a patient's full medical record across specialties in an aggregate, graphical format that enables a user to drill down for additional information and to determine severity within an anatomic structure for a patient over time.

In prior systems, users have had difficulty in viewing patient's record even when all data is present. There is no facility for determining severity of chronic patient issues. It has not been easy to see, in a single view, a patient's full health record across specialties. Even when a patient's clinical data is provided, most electronic medical records (“EMRs”) or electronic health records (“EHRs”) provide separate sections for radiology, cardiology, labs, etc., that are not aggregated in a single view so that you know immediately what's going on with the patient. Prior systems failed to provide a capability to determine a severity within an anatomic structure for a patient by time, for example.

From a patient perspective, he or she would like to see a view of his or her health and past history including treatment, medications, tests, etc., in one view. From a physician perspective, one view to show all health checkups of a patient's past can help avoid discontinuity of reporting across various domains and integrate various channels of reports to find a medical solution to a problem. Certain examples provide systems and methods to display a three-dimensional (3D) view of the body with different systems shadowed, emphasized, or highlighted. The view can provide a composite shadowed view of all body systems together for a patient and can be used across a treatment timeline, such as a complete duration of a patient's stay in a hospital through various stages. The composite view can be separated into its component anatomical system views (e.g., circulatory, skeletal, organ, etc.), for example. The anatomical system views) can be used as a solution for various end users, such as between a patient and a triage nurse to understand the patient's present health condition, past health history, and pending a health condition which was diagnosed but not treated; for a surgeon to explore multiple medical procedures on a patient 3D visualization; between a surgeon and a patient to explain the related medical procedure which will be conducted on patient; etc. The views) can form a visual part of an enterprise solution system, for example.

In some examples, anatomical views) can be further used for stereoscopic viewing during a medical procedure. Anatomical views) can be used to help reach medical solution(s) while discussing information with fellow surgeons, explain to a patient reducing the anxiety from patient point of view, and/or provide a sketchboard for the physician to explore/explain the medical procedure/treatment, for example.

In certain examples, systems and methods are provided to display one or more views (e.g., 2D and/or 3D view(s)) of a patient's body with different systems shadowed, emphasized, segmented, and/or highlighted. The anatomical views and associated indicators form a visual part of an Enterprise Clinical Information Solution, for example.

For example, if a patient has computer assisted diagnosis (CAD), then the patient's circulatory system is shown in a human figure with a block area marked with color, text, and/or other emphasis/highlighting. If the patient has also suffered from a fracture some years ago, a skeletal system is shown with the position of fracture indicated. Upon clicking and/or otherwise selecting the position, details can be viewed. If the patient underwent a cataract operation, for example, that will also be marked in the diagram (e.g., on an organ system view). In some examples, the various system views can be combined and separated into different patient anatomical and reporting views. By selecting a view and/or indicator of data within a view, a detailed view is generated to convey information regarding diagnosis, treatment, medication, physician specialist, time frame, etc.

In certain examples, patient details are displayed in text form via the user interface in conjunction with the visual anatomy depiction to help various end users of the system to explain diagnosis and/or treatment (e.g., between a patient who is visiting a second time and a nurse, between a physician/surgeon and a patient, etc.), explore a solution for a medical procedure (e.g., between two surgeons deciding on a medical procedure), maintain a visual history of a patient's health (e.g., hospital systems), etc.

When a patient goes to a hospital during a second or subsequent visit, he or she may have a detailed file (physical or virtual) on his or her health history. By providing alphanumerical data in conjunction with an image representation, an understanding of multiple health systems within a body can be more easily conveyed. For example, imagery and/or graphical representation can help a layperson understand coronary artery structure, function and condition. A visual representation can help ease the job of a healthcare practitioner, such as physician, nurse, or surgeon, if they can show what is the present condition and how it will be treated, for example. In some examples, two or more physician/surgeon can explore various possible solutions to a health problem in a person through 3D visual exploration.

The visual representation of a patient and its various systems which need attention from a physician has many benefits. The visual representation helps a patient and triage nurse understand the history of the patient's health. The visual representation helps the physician with whom the patient to know about the patient's history in one view. The physician can then look into individual treatment information to learn more. The physician can have a complete picture of the patient's health, ongoing/past medication, pattern of health, etc., and facilitate collaboration in an interlinked health challenge where two physician/surgeons work together. The physician can use the same image to explain to a patient his or her health condition and what he or she proposes as a medical solution. The same view can be used between surgeons to explore various medical procedures wherever required and then explain the finalized procedure to patient so as to reduce the patient's anxiety.

The visual representation(s) and patient view(s) can be tailored and presented in varying detail depending upon who is reviewing it, why, and when. For example, a simplified view can be presented during a triage stage, but a more detailed view can be provided during surgery. Information can be input to update the views and associated data. For example, 3D skeletal analysis information from a 3D digitizer can be input to display a 3D view of the patient's body with different systems identified. Additionally, in some examples, information can be output for clinical decision support and/or procedure execution.

Certain embodiments provide a graphical representation of a patient or portion of the patient anatomy in conjunction with a timeline to graphical illustrate and provide easy, aggregated access to a patient's record information across various sources. Certain embodiments enable a user to grasp the full extent of a patient's current and past health without searching through multiple systems. The representation is a multi-specialty graphical representation of a patient's health record, both anatomic and historical, for example.

A representation of a human figure is provided to illustrate what procedures a patient has undergone, to which anatomical part the procedures were applied, and what pathology was found, for example. Such information can be aggregated from a plurality of sources and shown on an anatomical representation. In certain embodiments, visual indicators, such as dots, icons, highlights, etc., can be used to indicate a data point on the anatomic figure.

For example, a representation can use dots to indicate data points in relation to the anatomy. Each dot indicates a procedure performed at that anatomical location, and a coloration of the dot indicates an outcome or diagnosis (e.g., good, bad, unknown, etc.). A user then can drill down into each dot to obtain an additional level of detail.

In certain embodiments, a user can hover over or click and see a report, image, etc. A user can also see an EHR timeline for the patient to see the dots/outcomes over time. That is, dots and/or other indicators represented on the anatomy can also be provided in an EHR timeline view for user analysis. Together the human figure representation and EHR timeline can serve as an anatomical dashboard. The representation can be a human figure, heart, lung, etc., whatever is appropriate. The representation can be a three-dimensional (“3D”) representation of a patient body, certain body part, certain body region, etc. When a user moves a cursor to one dot, the timeline can be scrolled according and vice versa. The timeline can be combined (e.g., overlaid) with the human figure, so the user sees a time series of the body or part itself, for example.

Patient data can be found in a plurality of formats including in Health Level Seven (“HL7”) messages, in Digital Imaging Communications in Medicine (“DICOM”) data, in structured reports, and in aggregated form, for example. Data can be received from a plurality of clinical information systems, such as a radiology information system (“RIS”), picture archiving and communication system (“PACS”), cardiovascular information system (“CVIS”), EMR, lab, physical exams, etc. Within HL7 messages, for example, a message includes a procedure code, a current procedural terminology (“CPT”) code, etc. A CPT code can be grouped by anatomical structure, for example, to indicate a laterality (left, right, etc.).

In mammography, for example, a user may be able to determine a diagnosis using a birads code. In other examples, depending on whether a decision support system is present, suppose a patient had a procedure one and then a procedure two. If a decision support system is present, the decision support system can direct the user to procedure two after procedure one resulted in a positive diagnosis, so the user can deduce that procedure one was a positive diagnosis, for example. If procedure two is not related to procedure one, for example, then the user can probably infer that one is negative because procedure two is going in a different direction. For example, suppose that procedure two is a surgery and procedure one is a positron emission tomography (“PET”)—computed tomography (“CT”) or PET—CT image, then the user can presume that the surgery is to remove cancer that was identified from a positive diagnosis in procedure one. If procedure two is the same as procedure one but is six months later, for example, then procedure two is probably a follow up for a diagnosis in procedure one.

In certain embodiments, the representation of the human figure includes dots and/or other graphical indicators that are representations of positive or negative outcomes, for example. Dots can also be representations of actual procedures (e.g., electrocardiogram (“EKG”) waveforms, x-ray and/or other image thumbnails, reports, charts, etc.). A user can position a cursor over an indicator to show the underlying content of that indicator, and can drill down into the human figure (e.g., drag a displayed cursor across and highlight or box an area and drill in or out of that area based on particular anatomical structures).

Certain embodiments provide methods and systems for presentation, search, discovery, drill down, retrieval, and/or examination of clinical information of various types, nature, and/or time period, which evidence is available in the PACS environment either in its intrinsic storage subsystems or through links to external information clinical systems including but not limited to Radiology Information Systems (RIS), Electronic Medical Records (EMR), Laboratory Information Systems, (RIS) Hospital Information Systems (HIS), Insurance Provider's Information Systems, and/or other archives and information systems, for example.

According to certain embodiments, a workstation screen can be dedicated to support multiple graphical and textual forms of presenting available main and collateral clinical evidence that can be easily searched, discovered, drilled down and retrieved for full blown presentation and analysis either on the same screen or on another screen of the workstation, for example. The specialized screen will be further referred as a “Workflow Screen”. The Workflow Screen can include a plurality of “Presentation Panes”—each pane representing a specialized view over the available clinical evidence in various perspectives including but not limited to: historical, anatomical, demographical, administrative, subspecialty, other perspective, and/or through a specialized mix of selected basic perspectives, for example.

According to certain embodiments, the combination of presentation panes can be pre-configured and/or personalized on multiple levels of an enterprise, administrative and/or subspecialty groups, or individual level, for example. The combination of presentation panes and/or behavior of each individual pane can be set to be context sensitive respective to a wide variety of factors including but not limited to patient personalized data, a nature of a medical case, and a current workflow as a whole, for example. One or more panes can adjust to a current step within an overall workflow, for example.

Content of the presentation panes can be synchronized between any two or more panes as part of a customization pattern, and/or by explicit choice of an operator, for example. For purposes of example only, selection of an anatomical region (e.g., an abdominal region) on anatomical presentation pane automatically reduces a list of historical exams to only those prior exams targeted to the selected anatomical part. As another example, a selection of “oncology” from an exam types list will focus primarily on clinical evidence gathered with respect to oncology while leaving other information in close proximity, but probably with less visible details and/or involving a series of actions (e.g., multiple mouse clicks) to be reached/drilled down.

All disclosed embodiments of the present invention can optionally feature the following properties: 1. Each presentation pane can have its different context sensitive graphical user interface (“GUI”) controls including but not limited to mouse operational modes, toolbars, right-click menus, others and/or a combination of the above, for example. 2. Graphical and/or overlay elements of each of presentation panes can be clickable and/or otherwise selectable resulting in a certain action happening upon clicking or selecting an element, thus being a special sort of interactive controls, for example.

It should be clear for any person skilled in the art that certain embodiments of the present invention should not be limited only to the multiplicity of disclosed embodiments. Alternatively these embodiments and/or nature of the information system should be considered as a convenient way of presenting basic principles, novelty concepts and inventive steps of certain embodiments of the present invention for the purpose of an application for patent.

Certain embodiments of the present invention are described in conjunction with graphical representation in the drawings. The invention itself should not be limited to the illustrative embodiments only. On the contrary, those embodiments should be regarded as particular examples of interactive systems and methods for effective search, discovery, data mining, drill down, retrieval and/or display for detailed examination of a piece or group of multidisciplinary clinical information for interpretation of examined media to help increase human productivity and interpretation quality, and/or help reduce a risk that an important piece of collateral evidence is missed.

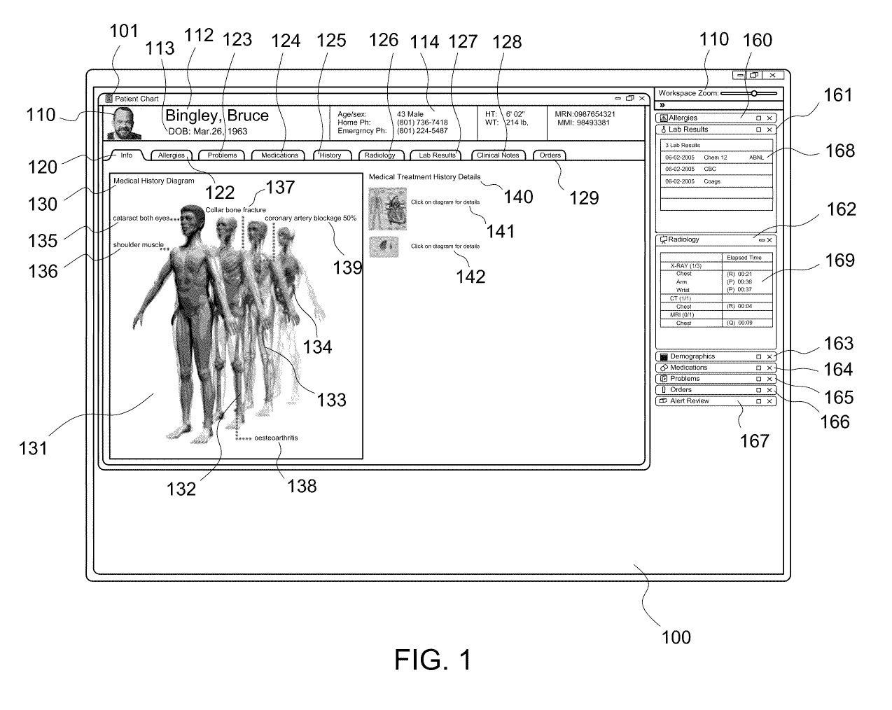

As illustrated, for example, in FIG. 1, a workflow manager 100 includes a patient chart 101. The patient chart 101 includes patient identifying information 110 such as a patient photograph or depiction 111, patient name 112, date of birth 113, as well as other demographic information 114 such as age, gender, phone number(s), height, weight, identification number(s), etc. The patient chart 101 includes a plurality of access tabs 120 including an information tab 121, allergies 122, problems 123, medications 124, history 125, radiology 126, lab results 127, clinical notes 128, orders 129, etc. A user can select a tab 120 for review and access to included information via the manager interface 100.

The information tab 121 includes a medical history diagram 130 including one or more anatomical representations 131-134 of the patient. Although not shown in the figure, the anatomical views 131-134 can be combined into a single composite view from which the individual body system views 131-134 can be separated or isolated for viewing, for example. The anatomical views include a musculature system view 131, a skeletal system view 132, a circulatory system view 133, and an organ system view 134, for example. Views can provide 2D and/or 3D anatomical views based on actual image(s) and/or idealized anatomical representations, for example.

Within each view 131-134 (and/or a composite view), one or more indicators 135-139 can be shown indicating medical data associated with the patient. For example, the anatomy representation 131-134 can include a graphical indication of findings and/or other events/conditions for the patient, areas of image data for the patient, and/or other information, for example. Such graphical indication can include a link to additional information, can trigger display of information in another pane, and/or can prompt a user to manually retrieve additional information, for example.

For example, medical data can indicate a diagnosis, treatment, exam, result, etc., associated with a particular body system and location for the patient. For example, the musculature view 131 can include a cataract indicator 135 and a shoulder muscle indicator 136. The skeletal representation 132 can include a collar bone fracture 137 and an osteoarthritis indicator 138. The circulatory view 133 can include a coronary artery blockage indicator 139, for example. By selecting a system view 131-134 and/or an indicator 135-139, a user can drill down or retrieve addition information and/or views, for example.

In addition to the medical history anatomical diagram(s) 130, the information tab 121 can include medical treatment history details 140. The history 140 can include, for example, one or more image studies 141-142 and/or associated documentation for retrieval and review by a user. In some examples, selection of a view 131-134 and/or indicator 135-139 populates the history details 140 with applicable content 141-142.

The workflow manager 100 also includes a workspace zoom function 150 to allow a user to configure and control the content, spacing, and/or interaction level of the manager 100. The manager 100 also includes one or more additional expandable windows including, for example, one or more of allergies 160, lab results 161, radiology 162, demographics 163, medications 164, problems 165, orders 166, alert review 167, etc. A user can select a window to view details such as individual lab results 168, image exams series 169, etc.

In certain examples, sections of the workflow manager 100 can provide access to additional information and/or functionality, such as patient history, dashboard information, etc. Certain examples can be implemented in conjunction with an information system for a healthcare enterprise including a PACS for radiology and/or other subspecialty system. Components of the workflow manager 100 can be implemented separately and/or integrated in various forms via hardware, software, and/or firmware, for example.

In some examples, the information tab 121 includes one or more orientation/viewing tools and/or one or more image view selectors, for example. Using the indicators 135-139 and/or source document information 141-142, a user can retrieve associated event documents, such as imaging studies, lab results, patient reports, etc., for further review, for example. In certain examples, a user mouse over or other cursor positioning over an indicator 135-139 displays a thumbnail of the corresponding document.

Indicators 135-139 can be used with the representation(s) 131-134 of the human figure to illustrate what procedures and/or examinations a patient has undergone, what anatomical part they were applied to, and what result (e.g., pathology) was found, for example. Data from a plurality of clinical sources can be aggregated for display via indicators 135-139 on the anatomical representation(s) 131-134. In certain examples, each indicator 133-139 indicates a procedure/exam, and a coloration of the indicator can be used to visually indicate an outcome of the procedure/exam diagnosis (e.g., good, bad, unknown, etc.). A user then can drill down into each of the indicators 135-139 to retrieve and review additional detail. A user can hover over or click on an indicator 135-139, for example, and see a corresponding report, image, etc. The anatomic representation(s) 131-134 can be shown as a two-dimensional (“2D”) outline of a human figure and/or portion of a human figure, the representation 131-134 can be a 3D representation of a body, certain body part, etc.

In certain embodiments, relationships between patient events, such as imaging studies and examinations, can be provided and/or deduced from information in patient data messages, for example. Event relationship information can be used to provide clinical decision support in addition to the graphical representation of events. Thus, an order in time, an affected anatomy, and a relationship between events can be provided via the interface 100.

Patient data can be found in HL7 messages, in DICOM information, in structured reports, and/or in other single and/or aggregated formats. Data is received from a variety of clinical information systems, including RIS, PACS, CVIS, EMR, lab, physical exams, etc. Anatomical structure and laterality can be extracted from message data, such as HL7 messages data. Relationship information can be extracted and/or deduced from an analysis of procedure timing and outcome according to certain guidelines/rules, for example. For example, for a procedure one and procedure two, if decision support rules indicate that procedure two follows a positive result in procedure one, the system 500 can deduce that procedure one had a positive diagnosis. However, an unrelated procedure two following procedure one may indicate that the result of procedure one was negative because procedure two does not fit the procedure pattern. As another example, if procedure two was a surgical operation and procedure one was a PET CT image series, then the system can presume that the surgical procedure was done to remove cancer found in a positive diagnosis from procedure one. If procedure two is the same procedure as procedure one but is six months later in time, then the system can deduce that procedure two is probably a follow up for a diagnosis made in procedure one, for example. Extracted and deduced patient and procedure information from one or more clinical sources can be used to construct the interface 100 depicted in FIG. 1, for example.

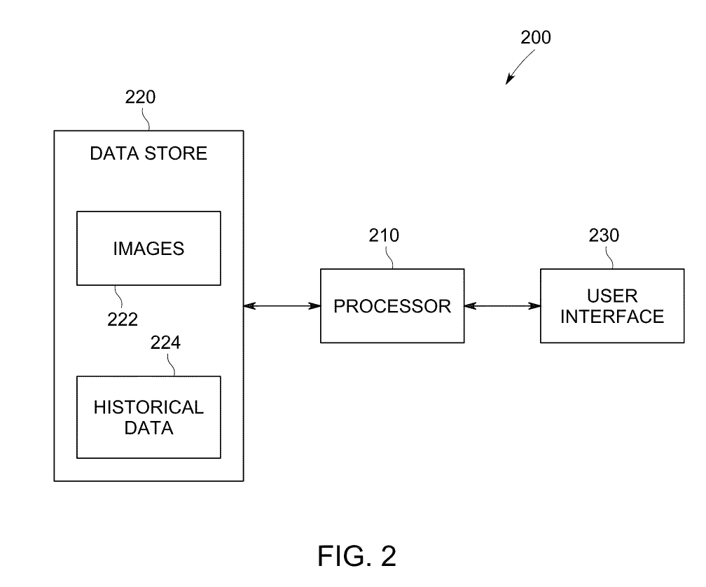

The workflow manager 100 can be implemented using an information system such as the patient information system 200 depicted in FIG. 2. The system 200 includes a processor 210, a data store 220, and a user interface 230. The data store 220 includes images 222 (e.g., patient and/or reference images), historical data 224 (e.g., reports, labs, electronic medical/health record data, etc.), etc. The components of the system 200 can be implemented individually and/or in various combinations in hardware, software, and/or firmware, for example. The processor 210 retrieves information 222, 224 from the data store 220 to generate one or more body system representations for display via the user interface 230. The body system representation(s) can be combined into a 2D/3D composite view for manipulation by a user and separation into one or more separate system (e.g., muscular, skeletal, circulatory, organ, etc.) views including one or more indicators of patient medical history (e.g., exams, labs, health conditions, etc.) selectable by the user to display further information associated with the selected indicator. In some examples, the user can modify information via the user interface 230 for storage in the data store 220. In some examples, information from the data store 220 can be routed to another clinical system, such as an electronic medical/health record system, a picture archiving and communication system, a radiology information system, a billing/order system, etc.

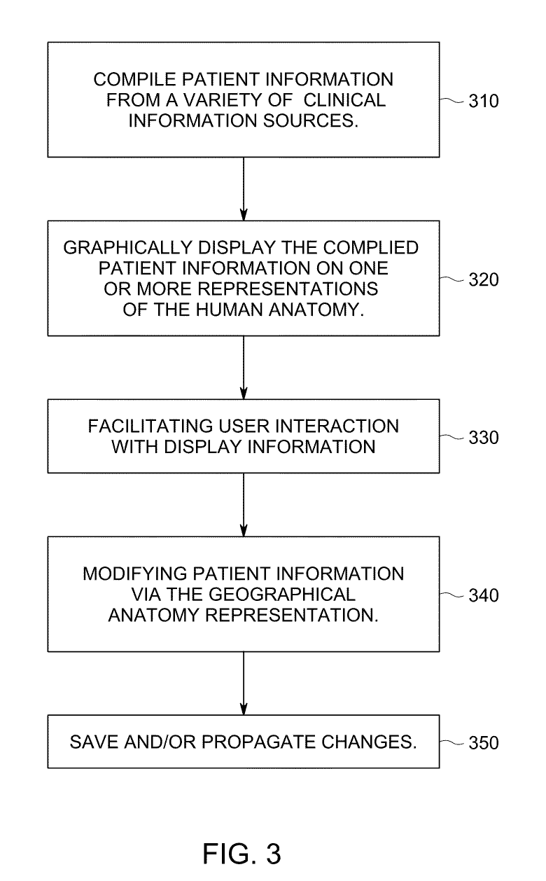

FIG. 3 depicts a flow diagram for an example method 330 for display of and interaction with patient clinical information via a visual anatomical representation. At 310, patient information for a particular patient is compiled from a variety of clinical information sources. For example, patient information, including patient image studies and/or other data, can be extracted and/or deduced from clinical information system messages being transmitted.

At 320, the compiled patient information is graphically displayed on at least one representation of the human anatomy (e.g., a 2D and/or 3D image, representation, or view of the human figure) in conjunction with supporting data/documents. For example, corresponding indicators (e.g., the indicators 135-139 shown in FIG. 1) can be shown on a composite and/or separate body system graphical anatomical representations (e.g., the representations 131-134 of FIG. 1) and made available for user interaction.

At 330, a user can interact with information depicted on a graphical anatomy view. For example, a user can position a cursor over an indicator on the human figure to display a thumbnail version of a corresponding document, such as an image, a report, an order, etc. A user can select an indicator to retrieve a full version of the document, for example. As another example, a user can select a certain type of imaging exam and all indicators corresponding to that type of exam will be highlighted.

At step 340, clinical evidence and/or other data can be modified via the graphical anatomy representation. For example, images, findings, and the like may be highlighted, annotated, etc. Clinical evidence and/or related findings can be modified, such as through generation of a report and/or notes regarding an image study. At step 350, any changes can be saved and/or propagated to other system(s).

One or more of the blocks of the method 300 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of the blocks and/or execute the blocks in a different order than the order listed. For example, some blocks may not be executed in certain embodiments of the present invention. As a further example, certain blocks may be executed in a different temporal order, including simultaneously, than listed above.

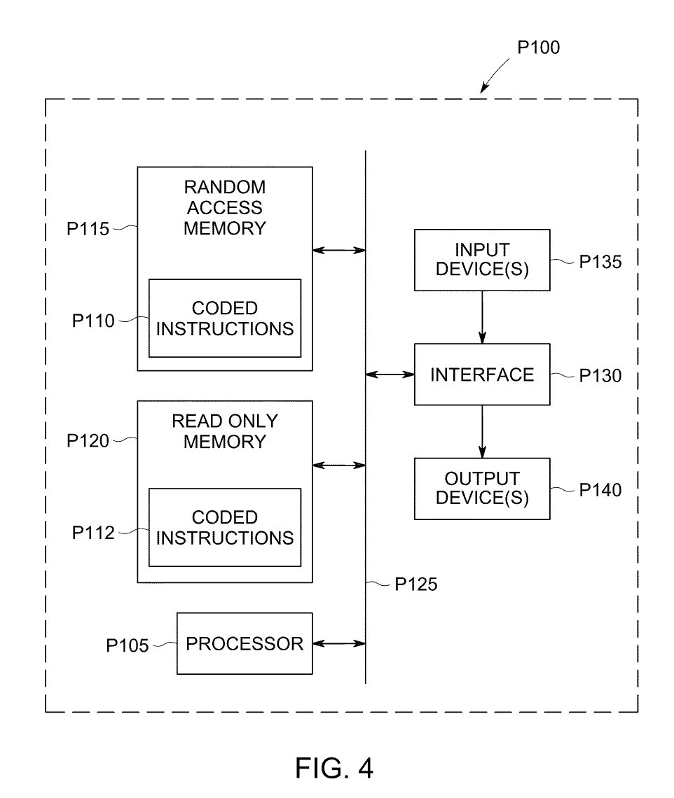

FIG. 4 is a schematic diagram of an example processor platform P100 that can be used and/or programmed to implement the example systems and methods described above. For example, the processor platform P100 can be implemented by one or more general-purpose processors, processor cores, microcontrollers, etc.

The processor platform P100 of the example of FIG. 4 includes at least one general-purpose programmable processor P105. The processor P105 executes coded instructions P110 and/or P112 present in main memory of the processor P105 (e.g., within a RAM P115 and/or a ROM P120). The processor P105 may be any type of processing unit, such as a processor core, a processor and/or a microcontroller. The processor P105 may execute, among other things, the example process of FIG. 3 to implement the example methods and apparatus described herein.

The processor P105 is in communication with the main memory (including a ROM P120 and/or the RAM P115) via a bus P125. The RAM P115 may be implemented by dynamic random access memory (DRAM), synchronous dynamic random access memory (SDRAM), and/or any other type of RAM device, and ROM may be implemented by flash memory and/or any other desired type of memory device. Access to the memory P115 and the memory P120 may be controlled by a memory controller (not shown). The example memory P115 may be used to implement the example databases described herein.

The processor platform P100 also includes an interface circuit P130. The interface circuit P130 may be implemented by any type of interface standard, such as an external memory interface, serial port, general-purpose input/output, etc. One or more input devices P135 and one or more output devices P140 are connected to the interface circuit P130. The input devices P135 may be used to, for example, receive patient documents from a remote server and/or database. The example output devices P140 may be used to, for example, provide patient documents for review and/or storage at a remote server and/or database.

Thus, certain embodiments provide a technical effect of graphically presenting patient health information with respect to particular anatomic structure over time. Certain embodiments provide a multi-specialty graphical representation of a patient's health record in both anatomic and historical context. Whereas prior approaches presented a user with difficulty in viewing a patient's record even when all available data was present and provided no facility for determining a severity of chronic patient issues, certain embodiments help a user to grasp a full extent of a patient's current and past health without manually searching through multiple systems.

It should be understood by any experienced in the art that the inventive elements, inventive paradigms and inventive methods are represented herein by certain exemplary embodiments only. However, the actual scope of the invention and its inventive elements extends far beyond selected embodiments and should be considered separately in the context of wide arena of the development, engineering, vending, service and support of the wide variety of information and computerized systems with special accent to sophisticated systems of high load and/or high throughput and/or high performance and/or distributed and/or federated and/or multi-specialty nature.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain example embodiments of the present invention can omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may include RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions include, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Examples can be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Examples can also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of example embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A patient information interface system presenting an aggregated, graphical view of patient anatomy and history, said system comprising:
a data store to include images and patient history information; and
a processor to implement a user interface to accept user input and provide:
a plurality of graphical representations of a human anatomy, each graphical anatomy representation providing a view of a body system, and each graphical anatomy representation to include one or more indicators corresponding to clinical events that have occurred in connection with a patient in the body system viewable through the graphical anatomy representation, each of the one or more indicators located at an anatomical location on the graphical representation affected by the clinical event corresponding to the indicator.

2. The system of claim 1, wherein each graphical representation comprises a three-dimensional representation of the human anatomy.

3. The system of claim 1, wherein the plurality of graphical representations are combined in a composite graphical representation of the human anatomy, each of the plurality of graphical representations separable from the composite representation to provide an individual body system view.

4. The system of claim 1, wherein the one or more indicators are provided from one or more of the plurality of clinical information sources and are deduced from information in clinical data messages from one or more of the plurality of clinical information sources.

5. The system of claim 1, wherein selection of one of the one or more indicators on the graphical representation displays a document corresponding to the clinical event for the patient.

6. The system of claim 1, wherein positioning a cursor over one of one or more indicators on the graphical representation displays a thumbnail view of a document corresponding to the clinical event for the patient.

7. The system of claim 1, wherein a characteristic of the one or more indicators indicates at least one of a type, a status, and a severity of the clinical event corresponding to the indicator.

8. The system of claim 1, further comprising a control to allow a user to manipulate a view of the graphical representation.

9. The system of claim 1, wherein the body system comprises at least one of a musculature system, a skeletal system, a circulatory system, and a organ system, each system to be associated with a separate graphical anatomy view.

10. A computer-implemented method for aggregating and displaying a graphical view of patient anatomy and history, said method comprising:
compiling patient information from a plurality of clinical information sources and identifying clinical events related to the patient based on the patient information;
graphically displaying the compiled patient information using a plurality of graphical representations of a human anatomy, each graphical anatomy representation providing a view of a body system, each of the graphical representations including a corresponding set of one or more indicators identifying clinical events that have occurred in connection with the patient for the body system shown in the view, each of the one or more indicators located at an anatomical location on the graphical representation affected by the clinical event corresponding to the indicator; and
facilitating user interaction with the displayed patient clinical event indicators on each of the graphical anatomy representations.

11. The method of claim 10, further comprising displaying a document corresponding to the clinical event for the patient based on selection by a user of one of the one or more indicators on the graphical anatomy representation.

12. The method of claim 10, further comprising displaying a thumbnail view of a document corresponding to the clinical event for the patient based on positioning by a user of a cursor over one of one or more indicators on the graphical anatomy representation.

13. The method of claim 10, wherein a characteristic of the one or more indicators indicates at least one of a type, a status, and a severity of the clinical event corresponding to the indicator.

14. The method of claim 10, wherein facilitating user interaction further comprises allowing a user to manipulate a view of the graphical representation.

15. The method of claim 10, wherein each graphical representation comprises a three-dimensional representation of the human anatomy.

16. The method of claim 10, wherein the plurality of graphical representations are combined in a composite graphical representation of the human anatomy, each of the plurality of graphical representations separable from the composite representation to provide an individual body system view.

17. The system of claim 1, wherein the body system comprises at least one of a musculature system, a skeletal system, a circulatory system, and a organ system, each system to be associated with a separate graphical anatomy view.

18. A machine readable storage medium having a set of instructions for execution on a computing device, the set of instructions, when executed on the computing device, causing the computing device to execute a method for aggregating and displaying a graphical view of patient anatomy and history, the method comprising:
compiling patient information from a plurality of clinical information sources and identifying clinical events related to the patient based on the patient information;
graphically displaying the compiled patient information using a plurality of graphical representations of a human anatomy, each graphical anatomy representation providing a view of a body system, each of the graphical representations including a corresponding set of one or more indicators identifying clinical events that have occurred in connection with the patient for the body system shown in the view, each of the one or more indicators located at an anatomical location on the graphical representation affected by the clinical event corresponding to the indicator; and
facilitating user interaction with the displayed patient clinical event indicators on each of the graphical anatomy representations.

19. The machine readable storage medium of claim 18, wherein each graphical representation comprises a three-dimensional representation of the human anatomy.

20. The machine readable storage medium of claim 18, wherein the plurality of graphical representations are combined in a composite graphical representation of the human anatomy, each of the plurality of graphical representations separable from the composite representation to provide an individual body system view.
